(19) United States
(12) Patent Application Publication
(10) Pub. No.: US 2026/0065311 A1
(43) Pub. Date: Mar. 5, 2026

(54) MARKETING SYSTEM UTILIZING POINTS PROVIDED BY PRODUCT SALES

(71) Applicants: SANGYUP LEE, Seoul (KR); DONGBIN HAN, Pyeongtaek-si (KR)

(72) Inventor: SANG YUP LEE, Seoul (KR)

(73) Assignees: SANGYUP LEE, Seoul (KR); DONGBIN HAN, Pyeongtaek-si (KR)

(21) Appl. No.: 19/278,937

(22) Filed: Jul. 24, 2025

(30) Foreign Application Priority Data
Aug. 30, 2024 (KR) 10-2024-0118074
Dec. 9, 2024 (KR) 10-2024-0181924

(51) Int. Cl. G06Q 30/0214; G06Q 30/0226; G06Q 50/00

(52) U.S. Cl. CPC G06Q 30/0214; G06Q 10/40; G06Q 30/0229; G06Q 30/0233

(57) ABSTRACT

A system includes the steps of: a producer terminal that produces a product accessing the service providing server and opening a first product sales site for a first product in the shopping mall using the creation tool provided by the service providing server, in order to sell the product it has produced; a plurality of influencer terminals accessing the service providing server and opening sales sites using the creation tool provided by the service providing server; some influencer terminals among the plurality of influencer terminals accessing the first product sales site and requesting sales authority for the first product; the producer terminal determining a selling influencer terminal to which sales authority is selectively granted according to the request of the some influencer terminals; and each of the selling influencer terminals mounting a sales banner including a first product sales address for the first product on its own sales site.

### CROSS REFERENCE TO RELATED APPLICATION OF THE DISCLOSURE

The present application claims the benefit of Korean Patent Application No. 10-2024-0118074 filed in the Korean Intellectual Property Office on Aug. 30, 2024, No. 10-2024-0181924 filed in the Korean Intellectual Property Office on Dec. 9, 2024, the entire contents of which are incorporated herein by reference.

### BACKGROUND OF THE DISCLOSURE

The present disclosure relates to a marketing system utilizing points provided during product sales, and more particularly, to a marketing system utilizing points provided during product sales, in which an influencer and followers involved in product sales jointly accumulate points according to purchasing activities, the accumulated points can be used in a number of fields, and which is designed to allow, for example, replacing cash with points or purchasing gift certificates.

Generally, “reward points” refer to accumulated scores that a business operator who provides predetermined products or services grants to a customer according to the customer's purchase amount or the number of transaction uses.

Recently, various industrial sectors have been operating reward point systems to increase the utilization rate of their services or products and to enhance customer satisfaction.

The provided reward points are used like cash to purchase specific products or services, or become objects of barter exchange with products or items corresponding to the accumulated points.

However, such conventional point accumulation and usage systems have a simple structure primarily designed for accumulating points according to a customer's purchasing activities and using them at specific affiliated stores. Although the conventional point accumulation system was useful for inducing customer participation and increasing loyalty, it had limitations in that the interaction between affiliated stores and customers was restrictive and the effective utilization rate of points was low, resulting in an insufficient economic circulation effect, due to limited places of use and inefficient management methods.

Meanwhile, although systems based on cryptocurrency using blockchain technology have recently emerged, opening new possibilities in the digital economy, illegal activities such as Ponzi schemes with some abnormal structures and cryptocurrency scams are emerging as social problems. Such problems undermine the trust between customers and affiliated stores, and particularly, fictitious systems without substantial economic profit generation are pointed out as the core of the problem.

Multi-level marketing of goods based on online platforms, which has recently emerged, is an infinite chain referral sale in which a consumer who has used a product recognizes its excellence and converts to a seller of his or her own accord, recommends it to people around, leading them to share the product, and this process of newly formed consumers converting to sellers is repeated, gradually expanding the sales scope of the product.

Looking at prior art related to the marketing system of the above method, Korean Patent Registration No. 10-2272281 (filed on Mar. 2, 2021, hereinafter referred to as ‘prior art document’) proposes various methods to an operator for the technical development of a network marketing system. However, the profit settlement system of this prior art document has a disadvantage in that only sellers corresponding to a high rank receive benefits.

That is, in the case of a seller corresponding to a low rank or a seller who joined late, the phenomenon of imbalance, where the compensation is at a very low level or even not provided at all, is intensified, and due to this, the morale of customers is lowered or illegal acts of using various tricks to escape the low rank become frequent.

If cryptocurrency and multi-level systems operate based only on inducing new participation among users without actual profit generation, this can cause serious economic losses to customers.

Accordingly, there is a need for a solution that can strengthen trust among customers based on actual purchase data and that can achieve fair profit distribution simultaneously with profit generation, unlike the fraudulent systems pointed out as social problems.

### PRIOR ART LITERATURE

[Patent literature] Korean Patent Registration No. 10-2272281.

### SUMMARY OF THE DISCLOSURE

An object of the present invention is to provide a point utilization system having structural transparency and economic substance based on mutual benefits among a customer, an influencer, and a producer terminal, by providing a legitimate profit distribution structure based on actual purchase data.

Another object of the present invention is to provide a point utilization system in which points generated from a customer's purchasing activities are linked with actual economic activities, and which can maximize the benefits given to the customer through non-expiring points and various places of use, and at the same time can provide a local economy vitalization and economic circulation effect through the use of the points.

Furthermore, another object of the present invention is to provide a point utilization system that allows a producer who produces a product to simultaneously achieve a reduction in debt burden and an increase in profitability.

To achieve the above object, the present invention provides a system for selling a product through a service providing server (100) which is equipped with a shopping mall and provides and manages a creation tool for a plurality of producers to open product sales sites, the system comprising the steps of: a producer terminal (200) that produces a product accessing the service providing server and opening a first product sales site (210) for a first product in the shopping mall (101) using the creation tool (120) provided by the service providing server, in order to sell the product it has produced; a plurality of influencer terminals accessing the service providing server (100) and opening sales sites using the creation tool (120) provided by the service providing server, in order to sell products registered in the shopping mall operated by the service providing server; some influencer terminals among the plurality of influencer terminals accessing the first product sales site (210) and requesting sales authority for the first product; the producer terminal (200) determining a selling influencer terminal to which sales authority is selectively granted according to the request of the some influencer terminals; and each of the selling influencer terminals mounting a sales banner (300a) including a first product sales address for the first product on its own sales site, wherein, as a plurality of followers exist for the selling influencer terminal that has been granted the sales authority for the first product, the plurality of follower terminals sell the first product by mounting a sales banner of the first product sold by the selling influencer terminal on a site operated by each of the plurality of followers, and distributing points according to the sale to the influencer and the plurality of followers who were involved in selling the first product.

In addition, a plurality of influencer terminals are involved in the sale of the first product, and a plurality of follower terminals also exist that follow each of the influencers involved in the sale of the first product.

And, when there are three influencer terminals involved in the sale of the first product and two follower terminals following each of the influencers respectively, the influencer terminals involved in the sale of the first product are a 1-1 influencer terminal, a 1-2 influencer terminal, and a 1-3 influencer terminal, and the follower terminals for the 1-1 influencer terminal are a 1-1-1 terminal and a 1-1-2 terminal, the follower terminals for the 1-2 influencer terminal are a 1-2-1 terminal and a 1-2-2 terminal, and the follower terminals for the 1-3 influencer terminal are a 1-3-1 terminal and a 1-3-2 terminal, such that 1-1 points generated when the 1-1-1 terminal or the 1-1-2 terminal purchases the first product can be distributed to the 1-1 influencer terminal, the 1-1-1 terminal, and the 1-1-2 terminal, 1-2 points generated when the 1-2-1 terminal and the 1-2-2 terminal purchase the first product can be distributed to the 1-2 influencer terminal, the 1-2-1 terminal, and the 1-2-2 terminal, and 1-3 points generated when the 1-3-1 terminal and the 1-3-2 terminal purchase the first product can be distributed to the 1-3 influencer terminal, the 1-3-1 terminal, and the 1-3-2 terminal.

In addition, a part of the 1-1 points, a part of the 1-2 points, and a part of the 1-3 points can also be distributed to the service provider operating the service providing server (100), such that the 1-1 points, the 1-2 points, and the 1-3 points are divided into sales-related points (250a), which can be distributed to the 1-1 influencer terminal, the 1-1-1 terminal, the 1-1-2 terminal, the 1-2 influencer terminal, the 1-2-1 terminal, the 1-2-2 terminal, the 1-3 influencer terminal, the 1-3-1 terminal, and the 1-3-2 terminal, who were involved in the sale of the first product, and management-related points (250b), which are provided to the service provider.

In addition, the 1-1 points, the 1-2 points, and the 1-3 points are a liability incurred by the producer terminal due to the sale of the first product, and the producer terminal sells (settles) the 1-1 points, the 1-2 points, and the 1-3 points to the service provider to extinguish the liability held by the producer terminal, and the service provider can take responsibility for and operate the liability.

And, as the producer terminal sells the liability to the service provider, when the total points (250c) of the 1-1 points, the 1-2 points, and the 1-3 points are assumed to be 100, the producer terminal can convert the remaining points, excluding the cash loss points (261) which are a part of the total points (250c), into cash and provide it to the service provider.

In addition, when the service provider refers to the transferred total points (250c) as liability points (260) and the provided cash as cash profit funds (262), the service provider expands the usage rights so that member terminals that can use the liability points (260) can also use the liability points (260) at other businesses for which the producer terminal has not given permission for use, and if the member terminal uses the liability points (260) at the other businesses, the service provider can provide less cash than the liability points (260) used by the member terminal to the other businesses and acquire liability utilization points (265).

In addition, the other businesses include restaurants, bakeries, convenience stores, and movie theaters, thereby allowing the member terminals that can use the liability points (260) to use the liability points (260) in a number of fields.

In addition, the service provider can extend the usage period of the liability points (260) indefinitely to provide an environment where the member terminals that can use the liability points (260) can use all of the liability points (260).

In addition, when the service provider operates the product sales site for a plurality of producers by mounting a shopping mall, the relationship among the liability utilization points (265) acquired by providing less cash to the other businesses than the liability points (260) used by the member terminal, the cash loss points (261) that the producer terminal does not provide when providing cash corresponding to the total points (250c), and the management-related points (250b) provided from the producer terminal can be designed such that “cash loss points (261)<liability utilization points (265)+management-related points (250b)” so that the service provider can realize a profit when selling the first product.

In addition, a distribution ratio of the sales-related points (250a) provided to the 1-1-1 terminal and the 1-1-2 terminal, which include the 1-1 influencer terminal, is determined by the 1-1 influencer terminal, a distribution ratio of the sales-related points (250a) provided to the 1-2-1 terminal and the 1-2-2 terminal, which include the 1-2 influencer terminal, is determined by the 1-2 influencer terminal, and a distribution ratio of the sales-related points (250a) provided to the 1-3-1 terminal and the 1-3-2 terminal, which include the 1-3 influencer terminal, is determined by the 1-3 influencer terminal, such that, the 1-1-1 terminal and the 1-1-2 terminal can sell the first product by following the 1-2 influencer terminal or the 1-3 influencer terminal instead of the 1-1 influencer terminal, the 1-2-1 terminal and the 1-2-2 terminal can sell the first product by following the 1-1 influencer terminal or the 1-3 influencer terminal instead of the 1-2 influencer terminal, and the 1-3-1 terminal and the 1-3-2 terminal can sell the first product by following the 1-1 influencer terminal or the 1-2 influencer terminal instead of the 1-3 influencer terminal.

Furthermore, the 1-1-2 terminal can sell the first product by following the 1-2-1 terminal or the 1-3-1 terminal instead of the 1-1-1 terminal, the 1-2-2 terminal can sell the first product by following the 1-1-1 terminal or the 1-3-1 terminal instead of the 1-2-1 terminal, and the 1-3-2 terminal can sell the first product by following the 1-1-1 terminal or the 1-2-1 terminal instead of the 1-3-1 terminal.

The features and advantages of the present invention will become more apparent from the following detailed description with reference to the accompanying drawings.

### BRIEF DESCRIPTION OF THE DRAWINGS

The above and other objects, features and advantages of the present disclosure will be apparent from the following detailed description of the preferred embodiments of the disclosure in conjunction with the accompanying drawings, in which:

FIG. 1 is a flowchart schematically illustrating a point utilization system of a product sales service providing site according to an embodiment of the present invention.

FIG. 2 is a block diagram schematically illustrating the configuration of a point utilization system of a product sales service providing site according to an embodiment of the present invention.

FIG. 3 is a conceptual diagram illustrating product sales sites of a producer terminal according to an embodiment of the present invention.

FIG. 4 is a conceptual diagram illustrating sales sites of a first product respectively created by a selling influencer terminal and a distribution seller according to an embodiment of the present invention.

FIG. 5 is a block diagram illustrating an influencer and a follower involved in the sale of a first product in a point utilization system according to an embodiment of the present invention.

FIG. 6 is a conceptual diagram illustrating a distribution state of points generated by purchasing a first product in a point utilization system according to an embodiment of the present invention.

FIG. 7 is a conceptual diagram visually illustrating the concept of total points of a point utilization system according to an embodiment of the present invention.

FIG. 8 is a conceptual diagram illustrating a point operation state between a producer terminal and a service provider of a point utilization system according to an embodiment of the present invention.

FIG. 9 is conceptual a diagram visually illustrating the concept of total points and liability points of a point utilization system according to an embodiment of the present invention.

FIG. 10 is a conceptual diagram visually illustrating a point operation state designed for realizing the profit of a service provider according to an embodiment of the present invention.

FIG. 11 is a conceptual diagram schematically illustrating a sales site access path according to an embodiment of the present invention.

### DETAILED DESCRIPTION OF THE PREFERRED EMBODIMENTS

Hereinafter, preferred embodiments of the present invention will be described with reference to the accompanying drawings. In this process, the thickness of lines or the size of components shown in the drawings may be exaggerated for clarity and convenience of explanation.

In the drawings, reference numeral 100 refers to a service providing server, and 101 refers to a shopping mall. Reference numeral 105 refers to an influencer DB, and 120 refers to a creation tool. Reference numeral 200 refers to a producer terminal, and 210 refers to a first product sales site. Furthermore, 250a refers to sales-related points, 250b refers to management-related points, and 250c refers to total points. Reference numeral 260 refers to liability points, 261 refers to cash loss points, 262 refers to cash profit funds, and 265 refers to liability utilization points. Lastly, reference numeral 300a refers to a sales banner.

In addition, the terms described below are terms defined in consideration of the functions in the present invention, and these may vary according to the intention or custom of a user or an operator. Therefore, the definition of these terms should be made based on the content throughout this specification.

Furthermore, the following embodiments are merely exemplary matters of the components presented in the claims of the present invention and do not limit the scope of rights of the present invention, and embodiments including components that are included in the technical idea throughout the specification of the present invention and can be substituted with equivalents in the components of the claims may be included in the scope of rights of the present invention.

The present invention relates to a system for selling products through a service providing server (100) that can be linked with POS/kiosks of offline stores and mainly mounts a shopping mall to manage it, and is configured to include the service providing server (100); a producer terminal (200) that produces a product; and a plurality of influencer terminals. The service providing server (100) sells products by providing and managing a creation tool (120) with which a plurality of producer terminals (200) can open product sales sites.

A main feature of the present invention is to improve the structural limitations of the existing point system through an influencer-centered point accumulation and distribution method, and to maximize the transparency and economic efficiency of point operation. Hereinafter, the content of the present invention will be described in detail with reference to the accompanying drawings.

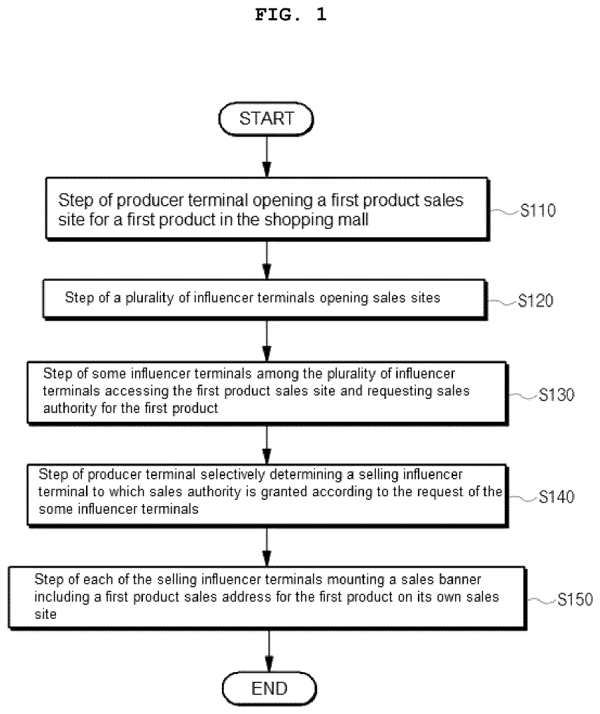

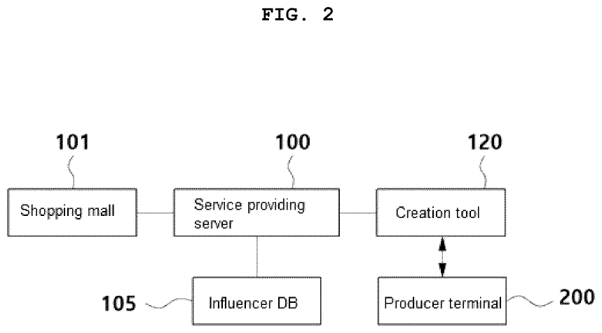

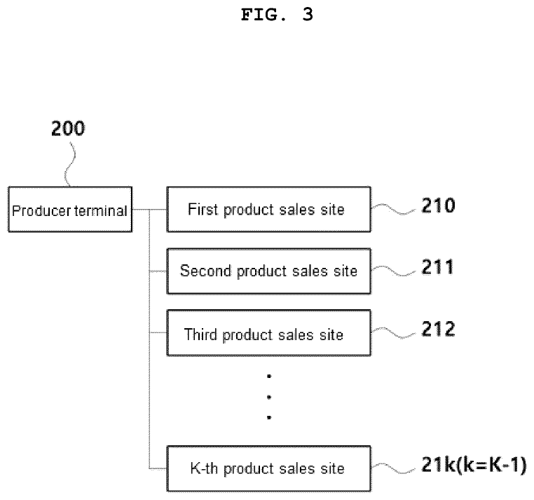

The attached FIG. 1 is a flowchart schematically illustrating a point utilization system of a product sales service providing site according to an embodiment of the present invention, FIG. 2 is a block diagram schematically illustrating the configuration of a point utilization system of a product sales service providing site according to an embodiment of the present invention, and FIG. 3 is a conceptual diagram illustrating product sales sites of a producer terminal according to an embodiment of the present invention.

Referring to FIG. 1 to FIG. 3 to explain the procedure of the marketing sales method, it includes a first step (S110) of the producer terminal (200) opening a first product sales site (210) for a first product in the shopping mall (101); a second step (S120) of a plurality of influencer terminals opening sales sites; a third step (S130) of some influencer terminals among the plurality of influencer terminals accessing the first product sales site (210) and requesting sales authority for the first product; a fourth step (S140) of the producer terminal (200) selectively determining a selling influencer terminal to which sales authority is granted according to the request of the some influencer terminals; and a fifth step (S150) of each of the selling influencer terminals mounting a sales banner including a first product sales address for the first product on its own sales site.

In the first step (S110), the producer terminal accesses the service providing server (100) to sell a product it has produced and opens a first product sales site (210) using the creation tool (120) provided by the service providing server.

In the subsequently performed second step (S120), the plurality of influencer terminals access the service providing server (100) to sell products registered in the shopping mall (101) operated by the service providing server (100), and open sales sites using the creation tool (120) provided by the service providing server (100). At this time, the service providing server (100) includes an influencer DB (105) to manage registered influencers.

The creation tool (120) may be one that provides a site creation solution based on a layout template, and thereby, the producer terminal and the influencer terminal have the advantage of being able to easily and quickly open a sales site without separately hiring professional personnel such as a web designer or a web programmer for opening the sales site.

Meanwhile, in the first step (S110), the producer terminal (200) can determine a sales commission for the first product. And in the fourth step (S140), each of the selling influencer terminals that has received the sales authority determines the sales conditions for the first product, wherein the sales conditions may include a step of determining the distribution ratio of the sales commission for the first product and the number of distribution sellers.

To explain this in more detail, the selling influencer terminal that has been granted the sales authority for the first product has a plurality of followers, and can determine some of its followers as distribution sellers, who are sub-sellers of the product. The plurality of follower terminals sell the first product by mounting the sales banner of the first product sold by the selling influencer terminal on the sites operated by each of the plurality of followers, and it is characterized by distributing points according to the sale to the influencer and the plurality of followers who were involved in selling the first product.

The points can be used at various places of use such as for purchasing gift certificates, at restaurants, beauty salons, etc. The point operating company cooperates with the places of use to secure a 1% profit at the time of settlement, and the places of use can obtain economic benefits that offset or exceed the corresponding cost through the effect of new customer influx.

That is, as the sales volume of the product increases, the selling influencer terminal is distributed a part of the sales commission preset by the producer terminal (200), thereby further strengthening the sales power of the corresponding product and activating sales.

In addition, according to an embodiment of the present invention, there are a plurality of influencer terminals involved in the sale of the first product, and there may also be a plurality of follower terminals following each of the influencers involved in the sale of the first product

In the above, the share of the service providing server (100) is also necessarily included in the distribution ratio of the sales commission. Therefore, the sum of the share of the selling influencer terminal, the shares of the distribution sellers, and the share of the service providing server (100) may be the same as the sales commission for the first product presented by the producer terminal (200). And in the above, the maximum ratio of the share of the selling influencer terminal is 50% of the sales commission, and the minimum ratio can be determined to be the same as the share of the distribution seller.

According to what has been described, the producer terminal of the present invention can not only easily sell products by utilizing influencer terminals, but also has the advantage of being able to easily manage the distribution and settlement of profits generated from product sales.

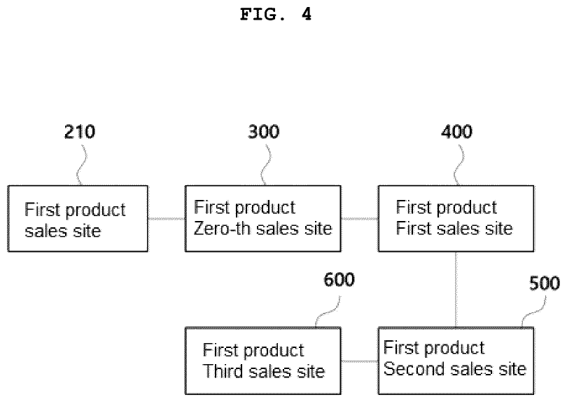

The attached FIG. 4 is a conceptual diagram illustrating sales sites of the first product respectively created by a selling influencer terminal and a distribution seller according to an embodiment of the present invention.

Referring to the attached FIG. 4, in the present invention, in order to maximize the ripple effect of word-of-mouth advertising, the number of distribution seller modules can be limited to a minimum of 2 and a maximum of 5. If there are 3 distribution seller modules and 3 distribution sellers belong to the selling influencer terminal, the sales site of the first product may include a zero-th sales site (300) operated by the selling influencer terminal, a first sales site (400) operated by a first sales terminal which is the first distribution seller terminal, a second sales site (500) operated by a second sales terminal which is the second distribution seller terminal, and a third sales site (600) operated by a third sales terminal which is the third distribution seller terminal.

At this time, each distribution seller module becomes the first sales site (400), the second sales site (500), and the third sales site (600), and although it has been described above that one distribution seller exists in each of the distribution seller modules, a plurality of distribution sellers may be configured to exist in each distribution seller module. Therefore, since a large number of distribution sellers gather under one selling influencer terminal, the product sales volume by the influencer increases.

Furthermore, if there are 5 distribution seller modules, a fourth sales site and a fifth sales site are added to FIG. 4, and many distribution sellers gather in each distribution seller module (e.g., the first to fifth sales sites) according to the fame of the influencer and the efforts of each distribution seller, and accordingly, the product sales quantity also increases rapidly.

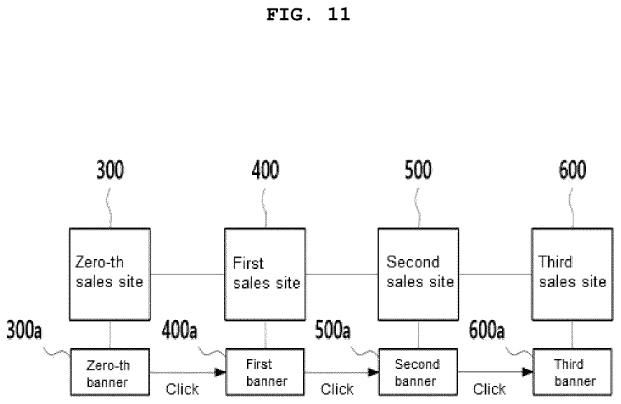

In addition, referring to FIG. 11, as each of the zero-th sales site, the first sales site, the second sales site, and the third sales site includes a respective ID, the zero-th sales site has a zero-th ID, the first sales site has a first ID, the second sales site has a second ID, and the third sales site has a third ID, and the zero-th sales site (300) operated by the selling influencer terminal includes a zero-th banner (300a), the first sales site (400) includes a first banner (400a), the second sales site (500) includes a second banner (500a), and the third sales site (600) includes a third banner (600a). The first banner mounted on the first sales site is generated by an operation of the zero-th banner, and at this time, the first banner includes the zero-th ID and the first ID. The second banner mounted on the second sales site is generated by an operation of the first banner, and at this time, includes the zero-th ID, the first ID, and the second ID. The third banner mounted on the third sales site is generated by an operation of the second banner, and at this time, includes the zero-th ID, the first ID, the second ID, and the third ID. When an arbitrary terminal clicks one of the zero-th banner to the third banner, it connects to the sales site of the first product opened by the producer terminal, and the service providing server can check which banner the arbitrary terminal connected through. If the arbitrary terminal purchases the first product, the service providing server identifies the sales sites (e.g., the zero-th to third sales sites) that contributed to guiding the arbitrary terminal to the sales site of the first product through the ID included in each banner. Therefore, the sales commission can be distributed according to the distribution ratio of the sales commission.

Sometimes, when an influencer produces directly or a producer terminal attempts to sell directly, the producer terminal may open the zero-th sales site (300) and determine the distribution ratio of sales-related points (250a). Accordingly, a producer can transform into an influencer, or an influencer can transform into a producer. Furthermore, a distribution seller (i.e., a buyer) who is subordinate to an influencer can change the influencer, and in some cases, the distribution seller himself can become an influencer.

In addition, it is natural that each distributor terminal has a site where they can check their own distribution ratio.

Meanwhile, the number of selling influencer terminals of the present invention can increase, and such a selling influencer terminal can simultaneously be a customer who purchases a product, i.e., a buyer. In addition, it is a matter of course that a distribution seller, while performing the role of recommending a product to a customer, can also be a customer who purchases the product, i.e., a buyer.

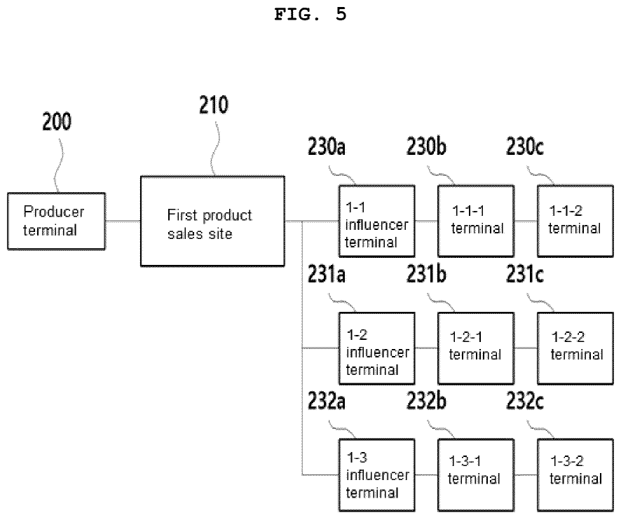

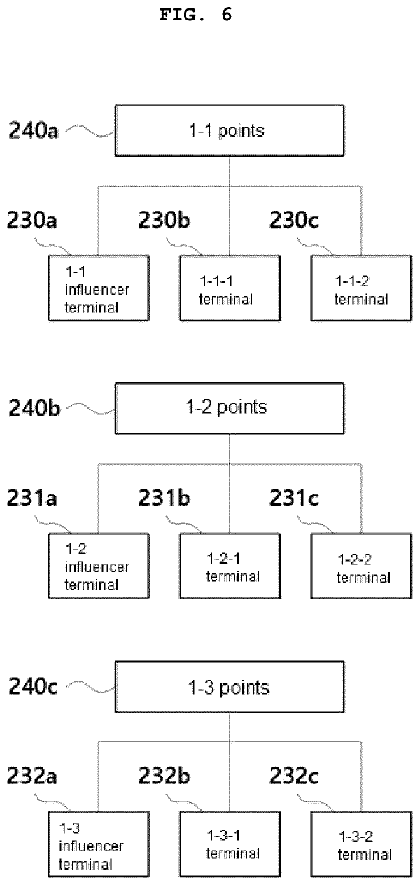

The attached FIG. 5 is a block diagram illustrating an influencer and a follower involved in the sale of a first product in a point utilization system according to an embodiment of the present invention, and FIG. 6 is a conceptual diagram illustrating a distribution state of points generated by purchasing the first product in the point utilization system according to an embodiment of the present invention.

FIG. 5 and FIG. 6, which illustrate an embodiment of the present invention, show a case where there are three influencer terminals involved in the sale of the first product, and there are two follower terminals following each of the influencers, respectively.

In the above embodiment, as the influencer terminals involved in the sale of the first product, there are a 1-1 influencer terminal, a 1-2 influencer terminal, and a 1-3 influencer terminal. And for the 1-1 influencer terminal, there are a 1-1-1 terminal and a 1-1-2 terminal as follower terminals; for the 1-2 influencer terminal, there are a 1-2-1 terminal and a 1-2-2 terminal as follower terminals; and for the 1-3 influencer terminal, there are a 1-3-1 terminal and a 1-3-2 terminal as follower terminals.

The present invention has three types of point presentation structures, and the point presentation targets are largely divided into three categories: influencers, distribution sellers (i.e., buyers), and the point operating company.

In the present invention, the customer who purchases a product becomes the subject of point accumulation. In order to realize mutual benefits among the follower who is a distribution seller recommending the product, the influencer, and the producer (small business owner), the 1-1 points generated when the 1-1-1 terminal or the 1-1-2 terminal purchases the first product can be distributed to the 1-1 influencer terminal, the 1-1-1 terminal, and the 1-1-2 terminal; the 1-2 points generated when the 1-2-1 terminal or the 1-2-2 terminal purchase the first product can be distributed to the 1-2 influencer terminal, the 1-2-1 terminal, and the 1-2-2 terminal; and the 1-3 points generated when the 1-3-1 terminal or the 1-3-2 terminal purchase the first product can be distributed to the 1-3 influencer terminal, the 1-3-1 terminal, and the 1-3-2 terminal. Hereby, the present invention has structural transparency and economic substance, strengthening trust among customers, and unlike fraudulent systems pointed out as social problems, it can actually generate profits.

Here, a distribution seller can be a buyer, and a buyer can also be a distribution seller. A distribution seller can change influencers, and a buyer can also change distribution sellers. That is, if necessary, the distribution seller can change the influencer as desired, the buyer can change the distribution seller, and the buyer can also become a distribution seller and change the influencer.

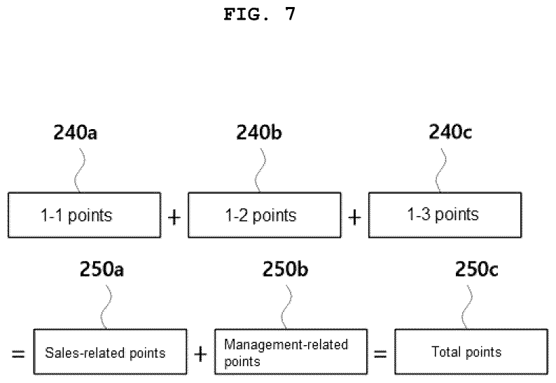

The attached FIG. 7 is a conceptual diagram visually illustrating the concept of total points of the point utilization system according to an embodiment of the present invention.

Referring to FIG. 7, a part of the 1-1 points, a part of the 1-2 points, and a part of the 1-3 points are also distributed to the service provider operating the service providing server (100). The total points (250c), which are the sum of the 1-1 points, the 1-2 points, and the 1-3 points, can be divided into sales-related points (250a), which are distributed to the 1-1 influencer terminal, the 1-1-1 terminal, the 1-1-2 terminal, the 1-2 influencer terminal, the 1-2-1 terminal, the 1-2-2 terminal, the 1-3 influencer terminal, the 1-3-1 terminal, and the 1-3-2 terminal, who were involved in the sale of the first product, and management-related points (250b), which are provided to the service provider.

In addition, the 1-1 points, the 1-2 points, and the 1-3 points are a liability incurred as the producer terminal sells the first product, and the producer terminal can sell (settle and deliver) the 1-1 points, the 1-2 points, and the 1-3 points to the service provider to extinguish the liability held by the producer terminal, and the service provider can take responsibility for and operate the liability.

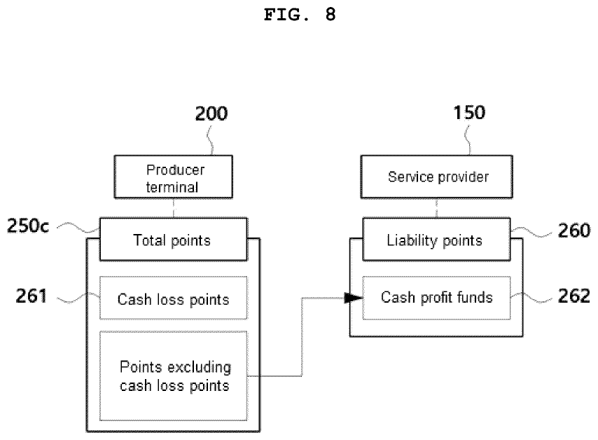

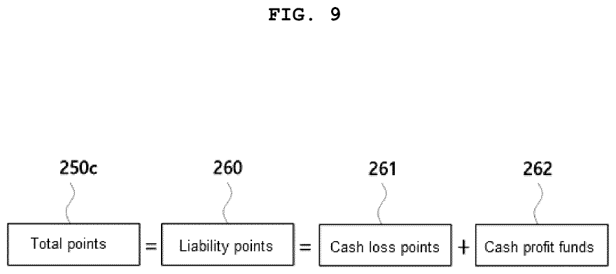

The attached FIG. 8 is a conceptual diagram illustrating a point operation state between the producer terminal and the service provider of the point utilization system according to an embodiment of the present invention, and FIG. 9 is a conceptual diagram visually illustrating the concept of total points and liability points of the point utilization system according to an embodiment of the present invention.

In addition, as the producer terminal sells the liability to the service provider, when the total points (250c) of the 1-1 points, the 1-2 points, and the 1-3 points are assumed to be 100, the producer terminal can convert the remaining points, excluding the cash loss points (261) which are a part of the total points (250c), into cash and provide it to the service provider.

Furthermore, according to a modified embodiment, when the producer terminal accumulates 1% of the sales amount as points, it can settle the points of the producer terminal at a discount of up to 10% and take them over, thereby enhancing the financial flexibility of the enterprise.

In addition, when the service provider refers to the transferred total points (250c) as liability points (260) and the provided cash as cash profit funds (262), the service provider expands the usage rights so that ‘member terminals’ that can use the liability points (260) can also use the liability points (260) at other businesses for which the producer terminal has not given permission for use, and if the member terminal uses the liability points (260) at the other businesses, the service provider provides less cash than the liability points (260) used by the member terminal to the other businesses and can acquire liability utilization points (265).

In the above, since the other businesses include restaurants, bakeries, convenience stores, and movie theaters, the member terminals that can use the liability points (260) can use the liability points (260) in a number of fields.

That is, according to an embodiment of the present invention, the liability points (260) can be commonly used not only by small business owner producers but also at various places of use, and at the places of use where the liability points are used, the settlement cost can be borne by the additional profit generated from attracting new customers, thereby increasing mutual benefits.

In addition, the service provider can extend the usage period of the liability points (260) indefinitely to provide an environment where the member terminals that can use the liability points (260) can use all of the liability points (260). According to the point utilization system of the present invention, there is no expiration date for points, so customers do not need to use the points in a hurry, and there is an advantage of long-term point management. This point system with no expiration date increases customer trust and prevents hasty use, thereby enhancing the long-term operational stability of the system.

Meanwhile, according to a modified embodiment, a customer who is the subject of receiving points can purchase gift certificates or convert them to cash under the condition of including Value Added Tax (VAT) when points of a certain amount or more are accumulated. Through this, the present invention contributes to increasing/securing tax revenue, and by securing the transparency of point operation, it has the effect of being able to strengthen the transparency of the national economy.

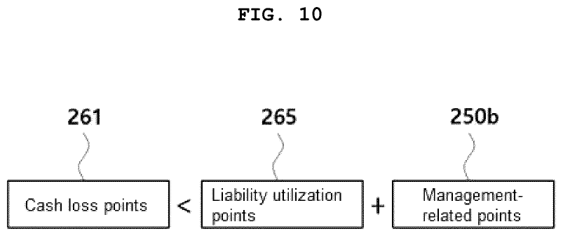

The attached FIG. 10 is a conceptual diagram visually illustrating a point operation state designed for realizing the profit of a service provider according to an embodiment of the present invention.

When the service provider operates the product sales site for a plurality of producers by mounting a shopping mall, the relationship among the liability utilization points (265) acquired by providing less cash to the other businesses than the liability points (260) used by the member terminal, the cash loss points (261) that the producer terminal does not provide when providing cash corresponding to the total points (250c), and the management-related points (250b) provided from the producer terminal can be designed such that “cash loss points (261)<liability utilization points (265)+management-related points (250b)” so that the service provider can realize a profit when selling the first product.

In addition, the present invention can provide a structure that does not generate a deficit even in the process of point discount settlement, in order for the service provider, which is a point operating company, to realize a stable profit model in operating points, by always securing 1% of sales as profit. For example, even if 1 million points generated from 10 million won in sales are settled at 900,000 won, a 10% discount, the accumulated points can be settled by adding the 100,000 won secured as 1% of sales. A structure like this guarantees sustainability that does not generate losses, unlike a Ponzi scheme.

Since points act as a liability for the producer terminal, which is the accumulation point, the producer terminal wants to settle this early. To this end, the present invention is designed to allow settlement and takeover of the producer terminal's points with up to a 10% discount when 1% of sales are accumulated as points, thereby alleviating the producer's debt burden. This provides a win-win effect for both the service provider, which is the point operating company, and the producer.

The distribution ratio of the sales-related points (250a) provided to the 1-1-1 terminal and the 1-1-2 terminal, which include the 1-1 influencer terminal, is determined by the 1-1 influencer terminal; the distribution ratio of the sales-related points (250a) provided to the 1-2-1 terminal and the 1-2-2 terminal, which include the 1-2 influencer terminal, is determined by the 1-2 influencer terminal; and the distribution ratio of the sales-related points (250a) provided to the 1-3-1 terminal and the 1-3-2 terminal, which include the 1-3 influencer terminal, is determined by the 1-3 influencer terminal.

Accordingly, the 1-1-1 terminal and the 1-1-2 terminal can sell the first product by following the 1-2 influencer terminal or the 1-3 influencer terminal instead of the 1-1 influencer terminal; the 1-2-1 terminal and the 1-2-2 terminal can sell the first product by following the 1-1 influencer terminal or the 1-3 influencer terminal instead of the 1-2 influencer terminal; and the 1-3-1 terminal and the 1-3-2 terminal can sell the first product by following the 1-1 influencer terminal or the 1-2 influencer terminal instead of the 1-3 influencer terminal.

Furthermore, the 1-1-2 terminal can sell the first product by following the 1-2-1 terminal or the 1-3-1 terminal instead of the 1-1-1 terminal; the 1-2-2 terminal can sell the first product by following the 1-1-1 terminal or the 1-3-1 terminal instead of the 1-2-1 terminal; and the 1-3-2 terminal can sell the first product by following the 1-1-1 terminal or the 1-2-1 terminal instead of the 1-3-1 terminal.

In addition, the point presentation ratio is flexibly adjusted according to the maximum point presentation limit, and the ratio for each target can vary depending on the situation, such as 10%, 8%, 7%, etc. If the maximum points are 10%, it is distributed as 1% to the influencer, 3% to the distribution seller, 5% to the buyer, and 1% to the service provider, and if it is a maximum of 8%, it can be adjusted to 1% to the influencer, 2% to the distribution seller, 4% to the buyer, and 1% to the service provider. This structure provides economic value to the influencer, the follower terminal who is a distribution seller that recommended the product, and the follower terminal who is a buyer that purchases the product, while maintaining the profitability of the service provider, which is the point operating company.

Meanwhile, according to a modified embodiment, the service provider, which is a point operating company, can generate additional profit by investing the pre-settled amount in safe assets. This can enhance stability, optimize system operating costs, and ensure the sustainability of the entire ecosystem.

As described above, the present invention maximizes the economic value among customers, producers, and service providers, and realizes a point system that combines reliability and transparency.

Although the present invention has been described in detail through specific embodiments, this is for the purpose of specifically explaining the present invention, and the present invention is not limited thereto, and it is clear that variations or improvements thereof are possible by a person of ordinary skill in the art within the technical spirit of the present invention.

Any simple variations or modifications of the present invention all within the scope of the present invention, and the specific scope of protection of the present invention will be clarified by the appended claims.

What is claimed is:

1. In a system for selling a product through a service providing server (100) which is equipped with a shopping mall and provides and manages a creation tool for a plurality of producers to open product sales sites, a marketing system utilizing points provided during product sales, the system comprising the steps of:
a producer terminal (200) that produces a product accessing the service providing server and opening a first product sales site (210) for a first product in the shopping mall (101) using the creation tool (120) provided by the service providing server, in order to sell the product it has produced;
a plurality of influencer terminals accessing the service providing server (100) and opening sales sites using the creation tool (120) provided by the service providing server, in order to sell products registered in the shopping mall operated by the service providing server;
some influencer terminals among the plurality of influencer terminals accessing the first product sales site (210) and requesting sales authority for the first product;
the producer terminal (200) determining a selling influencer terminal to which sales authority is selectively granted according to the request of the some influencer terminals; and
each of the selling influencer terminals mounting a sales banner (300a) including a first product sales address for the first product on its own sales site,
wherein, as a plurality of followers exist for the selling influencer terminal that has been granted the sales authority for the first product,
the plurality of follower terminals sell the first product by mounting a sales banner of the first product sold by the selling influencer terminal on a site operated by each of the plurality of followers, and
distributing points according to the sale to the influencer and the plurality of followers who were involved in selling the first product.

2. The marketing system utilizing points provided during product sales of claim 1,
wherein a plurality of influencer terminals are involved in the sale of the first product, and a plurality of follower terminals also exist that follow each of the influencers involved in the sale of the first product.

3. The marketing system utilizing points provided during product sales of claim 2,
wherein, when there are three influencer terminals involved in the sale of the first product and two follower terminals following each of the influencers respectively,
the influencer terminals involved in the sale of the first product are a 1-1 influencer terminal, a 1-2 influencer terminal, and a 1-3 influencer terminal,
the follower terminals for the 1-1 influencer terminal are a 1-1-1 terminal and a 1-1-2 terminal,
the follower terminals for the 1-2 influencer terminal are a 1-2-1 terminal and a 1-2-2 terminal, and
the follower terminals for the 1-3 influencer terminal are a 1-3-1 terminal and a 1-3-2 terminal, such that
1-1 points generated when the 1-1-1 terminal or the 1-1-2 terminal purchases the first product are distributed to the 1-1 influencer terminal, the 1-1-1 terminal, and the 1-1-2 terminal,
1-2 points generated when the 1-2-1 terminal and the 1-2-2 terminal purchase the first product are distributed to the 1-2 influencer terminal, the 1-2-1 terminal, and the 1-2-2 terminal, and
1-3 points generated when the 1-3-1 terminal and the 1-3-2 terminal purchase the first product are distributed to the 1-3 influencer terminal, the 1-3-1 terminal, and the 1-3-2 terminal.

4. The marketing system utilizing points provided during product sales of claim 3,
wherein a part of the 1-1 points, a part of the 1-2 points, and a part of the 1-3 points are also distributed to a service provider operating the service providing server (100), and
the 1-1 points, the 1-2 points, and the 1-3 points are divided into sales-related points (250a), which are distributed to the 1-1 influencer terminal, the 1-1-1 terminal, the 1-1-2 terminal, the 1-2 influencer terminal, the 1-2-1 terminal, the 1-2-2 terminal, the 1-3 influencer terminal, the 1-3-1 terminal, and the 1-3-2 terminal, who were involved in the sale of the first product, and management-related points (250b), which are provided to the service provider.

5. The marketing system utilizing points provided during product sales of claim 4,
wherein the 1-1 points, the 1-2 points, and the 1-3 points are a liability incurred by the producer terminal due to the sale of the first product, and the producer terminal sells the 1-1 points, the 1-2 points, and the 1-3 points to the service provider to extinguish the liability held by the producer terminal, and the service provider takes responsibility for and operates the acquired liability.

6. The marketing system utilizing points provided during product sales of claim 5,
wherein, as the producer terminal sells the liability to the service provider, the producer terminal provides to the service provider the remaining points, excluding cash loss points (261) which are a part of the total points (250c) of the 1-1 points, the 1-2 points, and the 1-3 points, converted into cash.

7. The marketing system utilizing points provided during product sales of claim 6,
wherein the service provider refers to the transferred total points (250c) as liability points (260) and the provided cash as cash profit funds (262), and
the service provider expands usage rights so that member terminals that can use the liability points (260) can also use the liability points (260) at other businesses for which the producer terminal has not granted permission for use, and
if the member terminal uses the liability points (260) at the other businesses, the service provider provides less cash than the liability points (260) used by the member terminal to the other businesses and acquires liability utilization points (265).

8. The marketing system utilizing points provided during product sales of claim 7,
wherein the other businesses include restaurants, bakeries, convenience stores, and movie theaters, thereby allowing the member terminals that can use the liability points (260) to use the liability points (260) in a number of fields.

9. The marketing system utilizing points provided during product sales of claim 8,
wherein the service provider extends the usage period of the liability points (260) indefinitely to provide an environment where the member terminals that can use the liability points (260) can use all of the liability points (260).

10. The marketing system utilizing points provided during product sales of claim 8,
wherein, when the service provider operates the product sales site for a plurality of producers by mounting a shopping mall,
the relationship among the liability utilization points (265) acquired by providing less cash to the other businesses than the liability points (260) used by the member terminal, the cash loss points (261) that the producer terminal does not provide when providing cash corresponding to the total points (250c), and the management-related points (250b) provided from the producer terminal is designed such that “cash loss points (261)<liability utilization points (265)+management-related points (250b)” so that the service provider realizes a profit when selling the first product.

11. The marketing system utilizing points provided during product sales of claim 3,
wherein a distribution ratio of the sales-related points (250a) provided to the 1-1-1 terminal and the 1-1-2 terminal, which include the 1-1 influencer terminal, is determined by the 1-1 influencer terminal,
a distribution ratio of the sales-related points (250a) provided to the 1-2-1 terminal and the 1-2-2 terminal, which include the 1-2 influencer terminal, is determined by the 1-2 influencer terminal, and
a distribution ratio of the sales-related points (250a) provided to the 1-3-1 terminal and the 1-3-2 terminal, which include the 1-3 influencer terminal, is determined by the 1-3 influencer terminal, such that,
the 1-1-1 terminal and the 1-1-2 terminal can sell the first product by following the 1-2 influencer terminal or the 1-3 influencer terminal instead of the 1-1 influencer terminal,
the 1-2-1 terminal and the 1-2-2 terminal can sell the first product by following the 1-1 influencer terminal or the 1-3 influencer terminal instead of the 1-2 influencer terminal, and
the 1-3-1 terminal and the 1-3-2 terminal can sell the first product by following the 1-1 influencer terminal or the 1-2 influencer terminal instead of the 1-3 influencer terminal.

12. The marketing system utilizing points provided during product sales of claim 3,
wherein a distribution ratio of the sales-related points (250a) provided to the 1-1-1 terminal and the 1-1-2 terminal, which include the 1-1 influencer terminal, is determined by the 1-1 influencer terminal,
a distribution ratio of the sales-related points (250a) provided to the 1-2-1 terminal and the 1-2-2 terminal, which include the 1-2 influencer terminal, is determined by the 1-2 influencer terminal, and
a distribution ratio of the sales-related points (250a) provided to the 1-3-1 terminal and the 1-3-2 terminal, which include the 1-3 influencer terminal, is determined by the 1-3 influencer terminal, such that,
the 1-1-2 terminal can sell the first product by following the 1-2-1 terminal or the 1-3-1 terminal instead of the 1-1-1 terminal,
the 1-2-2 terminal can sell the first product by following the 1-1-1 terminal or the 1-3-1 terminal instead of the 1-2-1 terminal, and
the 1-3-2 terminal can sell the first product by following the 1-1-1 terminal or the 1-2-1 terminal instead of the 1-3-1 terminal.

13. The marketing system utilizing points provided during product sales of claim 3,
wherein each of the selling influencer terminals, which has been granted sales authority through the process of the producer terminal (200) selectively determining the selling influencer terminal to which sales authority is granted according to the request of the some influencer terminals, determines sales conditions for the first product, wherein the sales conditions include determining the distribution ratio of the sales commission for the first product and the number of distribution sellers.

14. The marketing system utilizing points provided during product sales of claim 13,
wherein, when there are 3 distribution seller modules and 3 distribution sellers belong to the selling influencer terminal, the sales site of the first product includes a zero-th sales site (300) operated by the selling influencer terminal, a first sales site (400) operated by a first sales terminal which is the first distribution seller terminal, a second sales site (500) operated by a second sales terminal which is the second distribution seller terminal, and a third sales site (600) operated by a third sales terminal which is the third distribution seller terminal.

15. The marketing system utilizing points provided during product sales of claim 14,
wherein each of the zero-th sales site, the first sales site, the second sales site, and the third sales site includes a respective ID, such that the zero-th sales site has a zero-th ID, the first sales site has a first ID, the second sales site has a second ID, and the third sales site has a third ID,
the zero-th sales site (300) operated by the selling influencer terminal includes a zero-th banner (300a), the first sales site (400) includes a first banner (400a), the second sales site (500) includes a second banner (500a), and the third sales site (600) includes a third banner (600a),
the first banner mounted on the first sales site is generated by an operation of the zero-th banner, and at this time, the first banner includes the zero-th ID and the first ID,
the second banner mounted on the second sales site is generated by an operation of the first banner, and at this time, the second banner includes the zero-th ID, the first ID, and the second ID,
the third banner mounted on the third sales site is generated by an operation of the second banner, and at this time, the third banner includes the zero-th ID, the first ID, the second ID, and the third ID,
when an arbitrary terminal clicks one of the zero-th banner to the third banner, it connects to the sales site of the first product opened by the producer terminal, and the service providing server can check which banner the arbitrary terminal connected through, and
if the arbitrary terminal purchases the first product, the service providing server identifies the sales sites that contributed to guiding the arbitrary terminal to the sales site of the first product through the ID included in each banner, and the sales commission is distributed according to the distribution ratio of the sales commission.
